(19) United States
(12) Patent Application Publication
(10) Pub. No.: US 2013/0268232 A1
(43) Pub. Date: Oct. 10, 2013

(54) Informative Display for Statistical Positioning System

(71) Applicants: Sameera PODURI, Santa Clara, CA (US); Payam PAKZAD, Mountain View, CA (US); Rajarshi GUPTA, Sunnyvale, CA (US)

(72) Inventors: Sameera PODURI, Santa Clara, CA (US); Payam PAKZAD, Mountain View, CA (US); Rajarshi GUPTA, Sunnyvale, CA (US)

(73) Assignee: QUALCOMM INCORPORATED, San Diego, CA (US)

(21) Appl. No.: 13/467,842

(22) Filed: May 9, 2012

Related U.S. Application Data
(60) Provisional application No. 61/622,432, filed on Apr. 10, 2012.

(51) Int. Cl. G06F 15/00

(52) U.S. Cl. 702/150

(57) ABSTRACT

System and method for providing informative display for statistical positioning system are disclosed. In one embodiment, the method includes receiving a statistical distribution of user locations in an area, where the statistical distribution of user locations includes a plurality of points representing likelihood of a user at corresponding locations, generating a weighted statistical distribution of user locations using an inverse distance weighting function, determining one or more estimated locations of the user using the weighted statistical distribution, and displaying the one or more estimated locations of the user, or a representation of the weighted statistical distribution of user position in a display.

### CROSS REFERENCE TO RELATED APPLICATIONS

This application claims the benefit of Provisional U.S. Application Ser. No. 61/622,432, entitled “Informative Display for Statistical Positioning System,” filed Apr. 10, 2012, which is assigned to the assignee hereof, and expressly incorporated herein by reference.

### FIELD

The present disclosure relates to the field of mobile device positioning. In particular, the present disclosure relates to providing informative display for statistical positioning system.

### BACKGROUND

With the advent of the Internet, people could electronically access maps of many places from all over the globe. For example, maps provided by Internet Service Provider may give directions from point “A” to point “B”. These directions from web-based mapping services were relatively static. With the invention of satellite-positioning system (SPS) technology and ever-smaller electronic devices, however, so-called turn-by-turn directions could be provided dynamically as travelers journeyed toward their destination. The SPS technology works in most outdoor environments, however, it may be less effective for many indoor environments. In addition, in conventional applications, a statistical distribution of a user's position are typically provided in formats readable by machines and computers, and such information has not been provided as user interface via location-based services or navigation services to assist users in an indoor environment.

### SUMMARY

The present disclosure relates to providing informative display for statistical positioning system. According to embodiments of the present disclosure, a method of providing location information on a mobile device comprises receiving a statistical distribution of user locations in an area, where the statistical distribution of user locations includes a plurality of points representing likelihood of a user at corresponding locations, generating a weighted representation of the statistical distribution of user locations using an inverse distance weighting function, determining one or more estimated locations of the user using the weighted representation of the statistical distribution of user locations, and displaying the one or more estimated locations of the user in a display. The method of generating a weighted representation of the statistical distribution of user locations comprises using routing distance associated with a routing graph of the area, wherein the inverse distance weighting function is inversely proportional to the routing distance in accordance with the routing graph of the area.

The method of determining one or more estimated locations of the user comprises determining one or more peaks of the weighted representation of the statistical distribution of user locations in accordance with a predefined threshold value. The method of determining one or more estimated locations of the user further comprises identifying a highest peak of the weighted representation of the statistical distribution of user locations as an estimated location of the user. The method of determining one or more estimated locations of the user further comprises identifying the one or more peaks of the weighted representation of the statistical distribution of user locations as the one or more estimated locations of the user.

The method of providing location information on a mobile device further comprises providing navigation to a destination based, at least in part, on the one or more estimated locations of the user and a routing graph of the area, and providing navigation according to routing distances associated with the routing graph of the area. The method further comprises providing information about businesses near the one or more estimated locations of the user, and providing information about on sale merchandise near the one or more estimated locations of the user.

The method of providing location information on a mobile device further comprises displaying the one or more estimated locations of the user using one or more indicia. The method displays the one or more estimated locations of the user using a contour map, where the contour map represents levels of likelihood the user is in a region. The method further displays the one or more estimated locations of the user using a heat map, where the heat map represents levels of likelihood the user is in a region.

In another embodiment, a computer program product for providing location information on a mobile device comprises a non-transitory medium storing computer programs for execution by one or more computer systems. The computer program product further comprises code for receiving a statistical distribution of user locations in an area, where the statistical distribution of user locations includes a plurality of points representing likelihood of a user at corresponding locations, code for generating a weighted representation of the statistical distribution of user locations using an inverse distance weighting function, code for determining one or more estimated locations of the user using the weighted representation of the statistical distribution of user locations, and code for displaying the one or more estimated locations of the user in a display.

In yet another embodiment, a mobile device includes one or more processors, a statistical positioning module configured to work with the one or more processors, and a memory configured to store one or more estimated locations of a user. The statistical positioning module includes logic configured to receive a statistical distribution of user locations in an area, where the statistical distribution of user locations includes a plurality of points representing likelihood of a user at corresponding locations, logic configured to generate a weighted representation of the statistical distribution of user locations using an inverse distance weighting function, logic configured to determine one or more estimated locations of the user using the weighted representation of the statistical distribution of user locations, and a display module configured to cause a display to show the one or more estimated locations of the user.

In yet another embodiment, a system for providing location information to a user comprises one or more processors and a statistical positioning module, configured to work with the one or more processors. The statistical positioning module includes means for receiving a statistical distribution of user locations in an area, where the statistical distribution of user locations includes a plurality of points representing likelihood of a user at corresponding locations, means for generating a weighted representation of the statistical distribution of user locations using an inverse distance weighting function, means for determining one or more estimated locations of the user using the weighted representation of the statistical distribution of user locations, and a display module configured to cause a display to show the one or more estimated locations of the user.

### BRIEF DESCRIPTION OF THE DRAWINGS

The aforementioned features and advantages of the disclosure, as well as additional features and advantages thereof, will be more clearly understandable after reading detailed descriptions of embodiments of the disclosure in conjunction with the following drawings.

FIG. 1 illustrates a display of statistical distribution of user locations using a mobile device according to some aspects of the present disclosure.

FIG. 2 illustrates a method of generating a density histogram representing statistical distribution of user locations according to some aspects of the present disclosure.

FIG. 3A illustrates a single-point method in estimating a user location according to some aspects of the present disclosure.

FIG. 3B illustrates a multiple-points method in estimating user locations according to some aspects of the present disclosure.

FIG. 4 illustrates methods of displaying statistical distribution of user locations as a contour map and as a heat map according to some aspects of the present disclosure.

FIG. 5 illustrates a block diagram of an apparatus for providing informative display of statistical positioning information according to some aspects of the present disclosure.

FIG. 6 illustrates an exemplary flow chart implemented by the statistical positioning module of FIG. 5 according to some aspects of the present disclosure.

Like numbers are used throughout the figures.

### DESCRIPTION OF EMBODIMENTS

Descriptions of specific embodiments and applications are provided only as examples, and the general principles defined herein may be applied to other examples and applications without departing from the spirit and scope of the disclosure. Thus, the present disclosure is not intended to be limited to the examples described and shown, but is to be accorded the widest scope consistent with the principles and features disclosed herein.

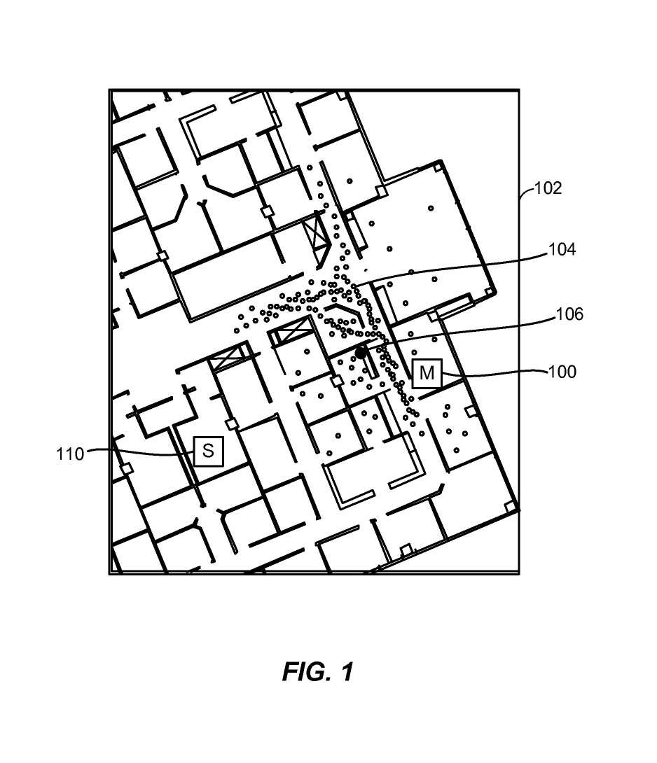

FIG. 1 illustrates a display of statistical distribution of user locations using a mobile device according to some aspects of the present disclosure. Note that in descriptions of the present disclosure, the terms user location, location of user, mobile device location, and location of mobile device are used interchangeably. In the example shown in FIG. 1, a mobile device 100 may obtain at least a portion of indoor environment characteristics from one or more servers 110. Upon receipt of indoor environment characteristics, the mobile device 100 may store indoor environment characteristics in one or more memories for use in providing at least one location-based service, e.g., for a user of mobile device. A location-based service may include, by way of example only, a positioning operation or a process that may be facilitated using a position resulting from a positioning operation, as is described further herein below.

In example implementations, exemplary indoor environment 102 may comprise one or more indoor areas such as office buildings, shopping malls, airports, apartment buildings, arenas, convention centers, auditoriums, amphitheaters, warehouses, classroom buildings, supermarkets, stadiums, a transit station terminal, a library, one or more floors thereof, interiors of other structures, or any combination thereof, just to name a few examples. In example implementations, indoor environment characteristics may be descriptive of the exemplary indoor environment 102 and may facilitate providing a location-based service, examples of which are described below. By way of example but not limitation, indoor environment characteristics may include one or more of any of the following: a schematic map, a connectivity graph for a schematic map, a routing graph for a schematic map, annotation information for a schematic map, points of interest for an indoor environment, navigational instructions, or any combination thereof, etc. Note that one or more servers 110 may be located external to the exemplary indoor environment 102. Alternatively, one or more servers 110 may be located fully or partially internal to exemplary indoor environment 102. Similarly, wireless transmitter may be located internal to the exemplary indoor environment 102, it may also alternatively be located fully or partially external to the exemplary indoor environment 102.

Referring to FIG. 1, one approach is to receive statistical distribution of user positions 104 in the form of discrete position samples (shown as particle positions) from an indoor navigation application. The mobile device may be configured to receive and display a mean position 106 of the statistical distribution as a point estimate along with an error margin. However, there may be drawbacks with this approach. For example, in cases when the distribution is multimodal, the mean position may be misleading. For instance, it may lie in an infeasible region of the map, such as outside of the indoor environment or in an inaccessible area, such as the mean position 106 shown in FIG. 1.

According to embodiments of the present disclosure, a venue may refer to an indoor environment where, e.g., indoor navigation service is deployed. A venue may refer to a physical place or locale that may be associated with the whereabouts of an object or thing (e.g., a user, or a mobile device, etc.) according to a desired or suitable point of reference represented, for example, via geographic coordinates (e.g., latitude, longitude, etc.), a street address, a governmental jurisdiction, a postal zip code, a name, or any combination thereof, etc. Additionally or alternatively, a venue may also include references to an altitude, a time, a direction, a distance, or any combination thereof, etc., just to illustrate other possible implementations. Depending on an implementation, venues may comprise, for example, various partially or substantially enclosed areas associated with an indoor environment, as described herein. A venue may make indoor environment characteristics available for access. For example, a venue may provide a schematic map of its indoor environment, together with locations of wireless transmitters. An interaction may occur offline, for instance. More specifically, at an example interaction, venue may provide one or more schematic maps or other indoor environment characteristics to server.

According to embodiments of the present disclosure, statistical distribution of user locations may be expressed as a probability map. A probability map may comprise one or more likelihood values that correspond to one or more positions of an indoor environment. For example, at least one likelihood value may correspond to one or more positions of an indoor environment. A statistical distribution may, for example, indicate one or more likelihoods of being in a particular state given a previous state. A statistical distribution may be used to determine likelihood values. A likelihood value may express a likelihood, e.g. in probabilistic terms, that a mobile device is located at or is to transition to a given position based on parameters corresponding to mobile device for at least one prior epoch (e.g., at least an immediately prior epoch). Such parameters may characterize position, movement, etc. of a mobile device at an instantaneous moment or over an elapsed time period. Examples of parameters characterizing position or movement of a mobile device may include, but are not limited to, an estimated position, a speed, a direction, a trajectory over an elapsed time period, or any combination thereof, etc. By way of example only, a probability map may correspond to an indoor environment and include multiple indications of likelihoods of mobile devices moving to or being located at various positions of the indoor environment based on a movement or location history of a mobile device.

A mobile device 100 may use likelihood values of a probability map, by way of example but not limitation, to establish or adjust a position fix. For example, if other positioning techniques or measured values result in a set of likely positions, the set of likely positions may be selected by identifying one or more positions in the set of likely positions having greater likelihood value(s) based at least in part on a probability map as compared to one or more other positions in the set of likely positions. For instance, a mobile device may consider a position, a direction, or a speed at a previous moment (e.g., from a previous state) in conjunction with probability map to determine one or more positions at which the mobile device is more probably positioned at a current moment (e.g., at a current state). These more probable positions that are determined at least partly based on probability map may be used to select the set of likely positions of the mobile device. Probability map may include a map of an indoor environment to which it corresponds. Additionally or alternatively, probability map may reference positions that are defined or otherwise specified in a map that is included as part of, e.g., schematic map.

Using instantaneous positions or tracked movement parameters of mobile devices, which may be received directly from such mobile devices, a server 110 may update a probability map to produce an updated probability map. For example, a server 110 may adjust likelihood values of a probability map based on where mobile devices are positioned over time or how mobile devices move (e.g., how positions, velocities, trajectories, or combinations thereof, etc. change over time) in an indoor environment. Mobile device positions may be determined, for example, using known trilateration-based techniques or using a statistical positioning model. With trilateration, for instance, a mobile device may use a mathematical formula or a look-up table that may define a functional relationship between received wireless signal characteristics (e.g., RSSI, RTT, RTD, etc.) and a range to one or more wireless transmitters. An updated probability map may be disseminated by server 110 directly to mobile device(s) 100 or indirectly to mobile device(s) 100 by transmitting an updated probability map to server 110.

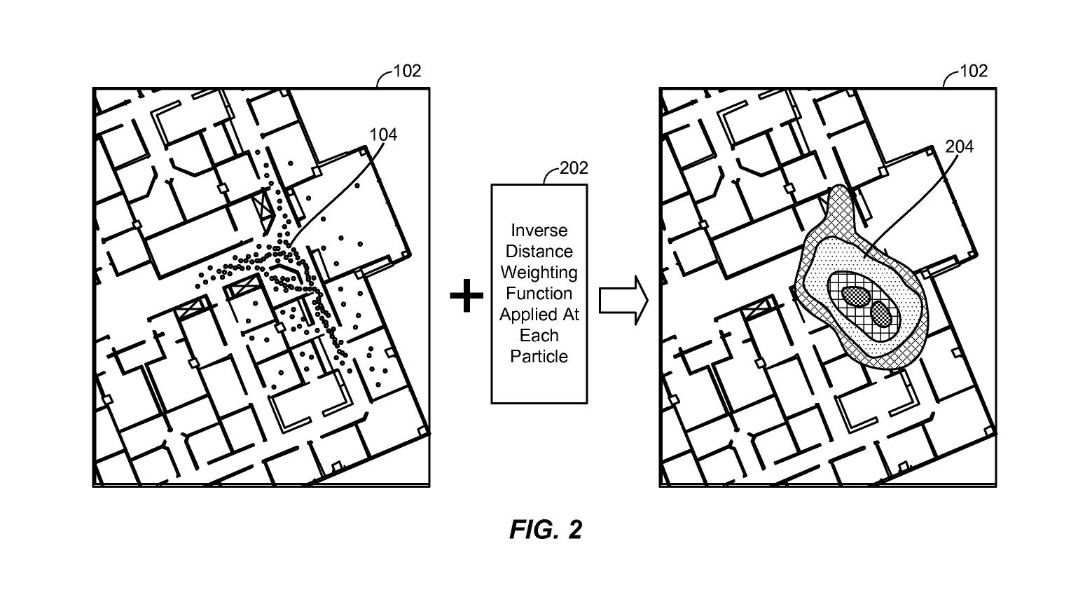

FIG. 2 illustrates a method of generating a weighted representation of statistical distribution of user locations according to some aspects of the present disclosure. As shown in FIG. 2, a display of an exemplary indoor environment 102 is shown with statistical distributions of user positions 104 (shown as particle positions) in the hallways as well as in the rooms. The method applies an inverse distance weighting function 202, which in this example implementation has the form wᵢⱼ=1/dᵢⱼ^{p}, where wᵢⱼ is the weight applied to the position j by sample particle i, dᵢⱼ is the distance between particles i and j, and p=2, at each particle position to generate a weighted representation of the statistical distribution of user locations (also referred to as density histogram of the statistical distribution of user locations) 204, which is a graphical representation showing a visual impression of the statistical distribution of user locations in the exemplary indoor environment 102. In generating the weighted representation of the statistical distribution of user locations, each particle receives votes from its neighbor particles. The weight of votes received may be inversely proportional to the distance from the particle. For example, votes from close neighbor particles carry higher weight than votes from particles further away from the particle. In other approaches, the inverse distance weighting function may be tuned to achieve different outcomes. For example, in the inverse distance weighting function described above, the value of the parameter p affects the shape of the resulting distribution—a large value of p creates a steep inverse distance weighting function that may be employed to achieve a large number of clusters, while a smaller value of p creates a flat inverse distance weighting function that may be employed to achieve a single peak at the mean position of the particles. In other implementations, a linear inverse distance weighting function, a second order inverse distance weighting function, a third or higher order inverse distance weighting function, may be applied at each particle position to generate a weighted representation of the statistical distribution of user locations. Note that while FIG. 2 is shown in black and white, the actual implementations may use color to designate the weighted representation of statistical distribution of user locations.

In some example implementations, an indoor environment may include one or more obstacles. Obstacles may include, but are not limited to, walls, doors, railings, or columns; furniture or cubicle dividers; elevators or stairs; or any combination thereof; etc. Obstacles may exist in the physical world and may have corresponding representation(s) included as part of a schematic map of indoor environment. Although claimed subject matter is not so limited, obstacles may thus include building features or other objects that may restrict movement around an indoor environment. On the other hand, indoor environments may also have open areas such as lobbies, common areas, entryways, or rooms, etc., just to name a few examples. Accordingly, because paths of movement in such an indoor environment may be restricted in some areas (although they may also be unrestricted in other, open areas), such an indoor environment may be an example of a constrained environment.

Feasible positions of a mobile device may comprise locations of indoor environment. Positions may have corresponding representation(s) included as part of a schematic map of indoor environment. Positions may also have counterpart locations in the physical world. Positions may be defined to any level of granularity or scale. For example, positions may be one inch, one foot, or ten feet apart, just to name a few examples. Positions may also be organized or arranged in any manner. By way of example only, positions may be organized into a grid of points, which may be associated with a local or global coordinate system and laid over a floor plan or other schematic map of indoor environment at substantially uniform spacing. A scale of a grid of points (e.g., an interval or distance between adjacent points) may be varied based, at least in part, on a desired level of precision for positioning or other location-based services, on an available amount of resources (e.g., memory, processing, etc.), on a size of a schematic map or rooms being covered, on any combination thereof, etc. In one particular implementation, grid points may be placed or positioned at sufficiently regular intervals so as to cover, for example, at least a portion of indoor environment.

A range may comprise, by way of example only, a radial distance between a mobile device and a wireless transmitter, with the radial distance capable of circumscribing at least a portion of a circle, such as an arc. At least one measured value (e.g., an RTT value, or an RTD value, etc.) by a mobile device with respect to e.g. a wireless transmitter may enable a mobile device to estimate a range between mobile device and wireless transmitter, as is known in the art. An RTT may be derived from, for example, one or more communication exchanges between a mobile device and one or more wireless transmitters of indoor environment. An arc or circle that is specified by a range may define a set of positions at which a mobile device is potentially located.

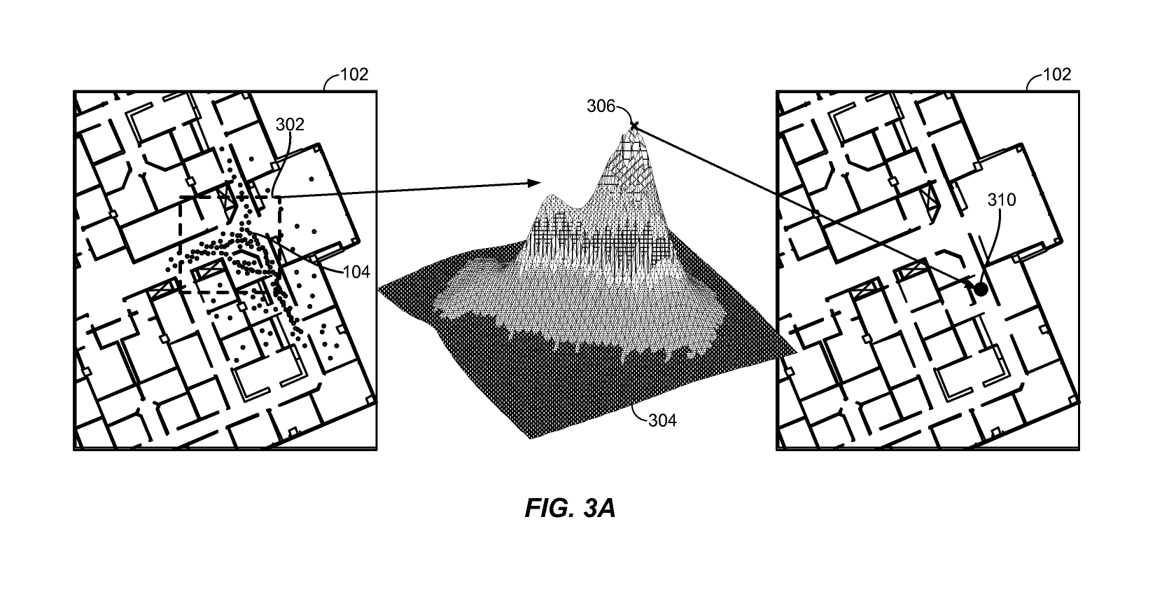

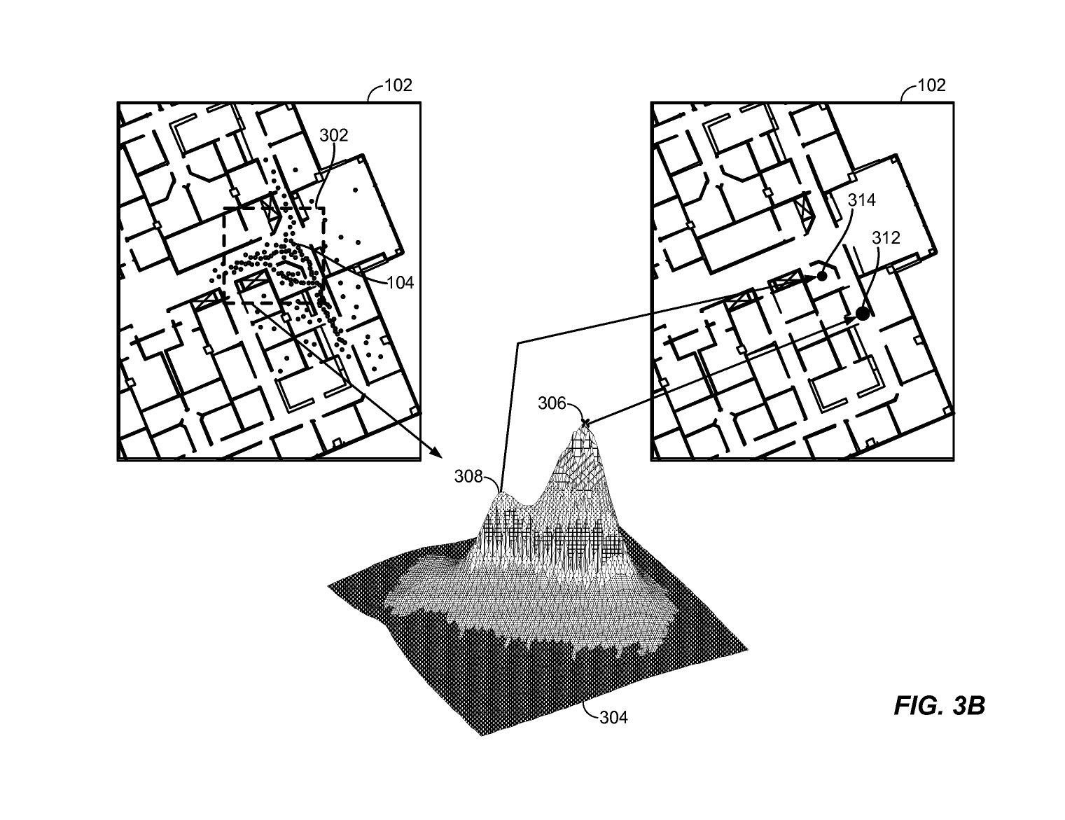

FIG. 3A illustrates a single-point method in estimating a user location according to some aspects of the present disclosure. In the example shown in FIG. 3A, descriptions of the exemplary indoor environment 102 and the statistical distribution of user locations 104 (particles) are similar to that of FIG. 1. In one approach, the method may identify a region of interest 302 in the exemplary indoor environment 102. It then computes a density histogram (also referred to as weighted representation of the statistical distribution of user locations) 304 of the statistical distribution of user locations 104 by applying an inverse distance weighting function to each particle in the region of interest 302. In the density histogram 304, a single point 306, which in this example represents the maximum of a posteriori estimate, may be identified as the mode of the user locations. Then, the mode 308 of the particle density histogram may be displayed to a user through an indoor navigation application running on a mobile device. Note that since the particles 104 may only lie in feasible regions, this approach guarantees that the mode is also a feasible position within the exemplary indoor environment 102.

FIG. 3B illustrates a multiple-points method in estimating user locations according to some aspects of the present disclosure. In this example, descriptions of the exemplary indoor environment 102, the statistical distribution of user locations 104 (particles), the region of interest 302, and the density histogram 304 are similar to that of FIG. 3A. In the approach shown in FIG. 3B, the method may identify a region of interest 302 in the exemplary indoor environment 102. It then computes a density histogram 304 of the statistical distribution of user locations 104. In the density histogram 304, multiple peaks (or points), may be identified to represent significant modes of the user locations, as indicated by numerals 306 and 308. The method may then display multiple peaks 306 and 308 of the particle density histogram 304, which are represented by dots 312 and 314 respectively.

According to embodiments of the present disclosure, the number of peaks may be based on a threshold of a user defined significant density. In the example shown in FIG. 3B, each peak may be displayed as a circle whose size is proportional to the peak density. The size of the circles 312 and 314 may be designed to indicate the relative weight of votes at each location. In this way, information may be conveyed to inform the user whether she is more likely be in one of the two locations 312 or 314. In this example, the user is more likely to be at location 312 than location 314 because the circle 312 is larger than circle 314. In other implementations, indicia, such as squares or triangles, may be used in place of the circles to indicate the likely locations of the user. Although this example employs two signification modes for illustration purposes, in other approaches, multiple significant modes (for example 3 or more) may be used in an indoor navigation application to assist the user. In those situations, a user-defined threshold may be configured to determine the number of peaks in the density histogram to be displayed. Note that when the particle distribution is clustered, the displayed points represent the number of significant clusters and their relative sizes. In situations when the distribution deviation is small, this method may result in a single point being displayed.

In the example shown in FIG. 1, the mean location 106 of the statistical distribution of user locations represents a minimized Euclidean distance to all particles. In some implementations, instead of using the mean location 106, the method may obtain the shortest obstacle-free path to particles from an underlying graph in an indoor navigation application, and use the shortest obstacle-free path to particles to compute a mean of the routing distances. The mean of the routing distances is an average of the particle positions calculated using routing distance. Note that the resulting mean of the routing distance may minimize expected routing distance. This approach can result in a more feasible position estimate than the Euclidean mean position described in FIG. 1 and it reflects how a user may travel in the indoor environment. For example, if particles are in the corridor surrounding a room, the Euclidean mean may be inside the room whereas the routing distance mean may be in the corridor. Using the routing distance approach, a trajectory computed from the statistical distribution of locations may be smoother because the trajectory would not be moving in and out of rooms through the walls as in the Euclidean distance approach.

According to embodiments of the present disclosure, the single-point method described in FIG. 3A and the multi-point method described in FIG. 3B may be employed to provide location-based services and navigation services. Location-based services and navigation services may include positioning, pedestrian navigation, real-time turn-by-turn directions, or location-based searching (e.g., searching of local points of interest), just to name a few examples. To provide location-based services indoors, one or more local coordinate systems may be established for particular indoor environments. An indoor environment may be referred to as a location context. A server may store and associate identifiers, such as location context identifiers (LCIs), with specific location contexts. A location context may include locally-defined areas or other environments such as, for example, particular floors of buildings or other indoor areas that may not be mapped according to a global coordinate system. Location context identifiers may be used as handles for requesting additional information associated with a location context (e.g., for requesting additional information that is laid over or linked to a schematic map of an indoor environment). Such additional information may include, by way of example but not limitation, routes or paths over an indoor map, points of interest that are local or unique to certain location contexts, etc., just to name a couple of examples. However, claimed subject matter is not limited to any particular coordinate system or systems or to any particular location context or identifier thereof. Moreover, a given indoor environment or local context may be associated with at least a portion of at least one local coordinate system, at least a portion of at least one global coordinate system, at least a portion of at least one local coordinate system that may be translated into one or more other local coordinate systems or global coordinate systems, or any combination thereof, etc., just to name a few examples.

A mobile device may use an identifier, such as a location context identifier, to obtain a schematic map of an indoor environment. Location-based data may be overlaid on a schematic map of an indoor environment. Additionally or alternatively, a mobile device may use an identifier to obtain information to be used in a particular application connected to a particular corresponding location context. For example, a mobile device may obtain information descriptive of a particular location context for use in an indoor pedestrian navigation application. Such information may include a schematic map that provides or enables a display of, for example, corridors, rooms, hallways, doors, entry ways, restrooms, or other points of interest of an indoor environment. For an example navigational application, such information may define a routing topology set out in a coordinate system that is local to a particular location context, as distinguishable from a global coordinate system. A mobile device may also use one or more identifiers to obtain point of interest (POI) information. POI information may include, by way of example only, information that describes or identifies particular locations or potential destinations of an indoor environment. Examples of POI information may include, but are not limited to, names of stores, locations of restrooms, names of office inhabitants, purposes of rooms, identifications of stairs or elevators, identifications of points of egress or ingress, or any combination thereof, etc. Use of information that is obtained in response to a request that specifies an identifier, such as a location context identifier, may depend, at least partially, on a position of a mobile device.

Note that there are specific situations and considerations with indoor environments. For example, many indoor environments may include walls or other obstacles. Interior obstacles may introduce at least two different difficulties. First, obstacles can block, reflect, attenuate, or otherwise affect wireless transmissions within an indoor environment. Second, obstacles can limit where it is feasible for a mobile device to be located within an indoor environment or how a mobile device may move within an indoor environment. A schematic map may show, by way of example only, locations of obstacles and feasible positions for mobile devices or users of mobile devices within an indoor environment. A schematic map for an indoor environment may therefore be used to facilitate navigation within the indoor environment.

In some implementations, a statistical positioning model may be utilized to facilitate navigation by aiding, for example, a positioning operation of a mobile device within an indoor environment. A positioning operation for a mobile device may, for example, determine at least an estimated position of the mobile device, including, but by way of example only, with respect to a schematic map. By way of example but not limitation, the statistical positioning module may link stored patterns of values to positions within an indoor environment or to distances to a wireless transmitter of an indoor environment. Stored value patterns may comprise or be derived from, by way of example but not limitation, at least one propagation parameter, at least one received signal strength indication/indicator (RSSI), at least one round trip time (RTT), at least one round trip delay (RTD), or any combination thereof, etc. For example, a statistical positioning model may include an RSSI value that corresponds to a particular position on a schematic map of an indoor environment. Or a statistical positioning model may include an RTT value that corresponds to a particular position on a schematic map of an indoor environment. Alternatively, a statistical positioning model may include a propagation parameter value that corresponds to a particular position on a schematic map or to a range to at least one wireless transmitter of an indoor environment. A statistical positioning model may include values derived from any one or more of these example measurements or from other values, which may be predicted or modeled, for each of multiple positions of a schematic map of an indoor environment. Statistical positioning models may also be realized in alternative implementations without departing from claimed subject matter.

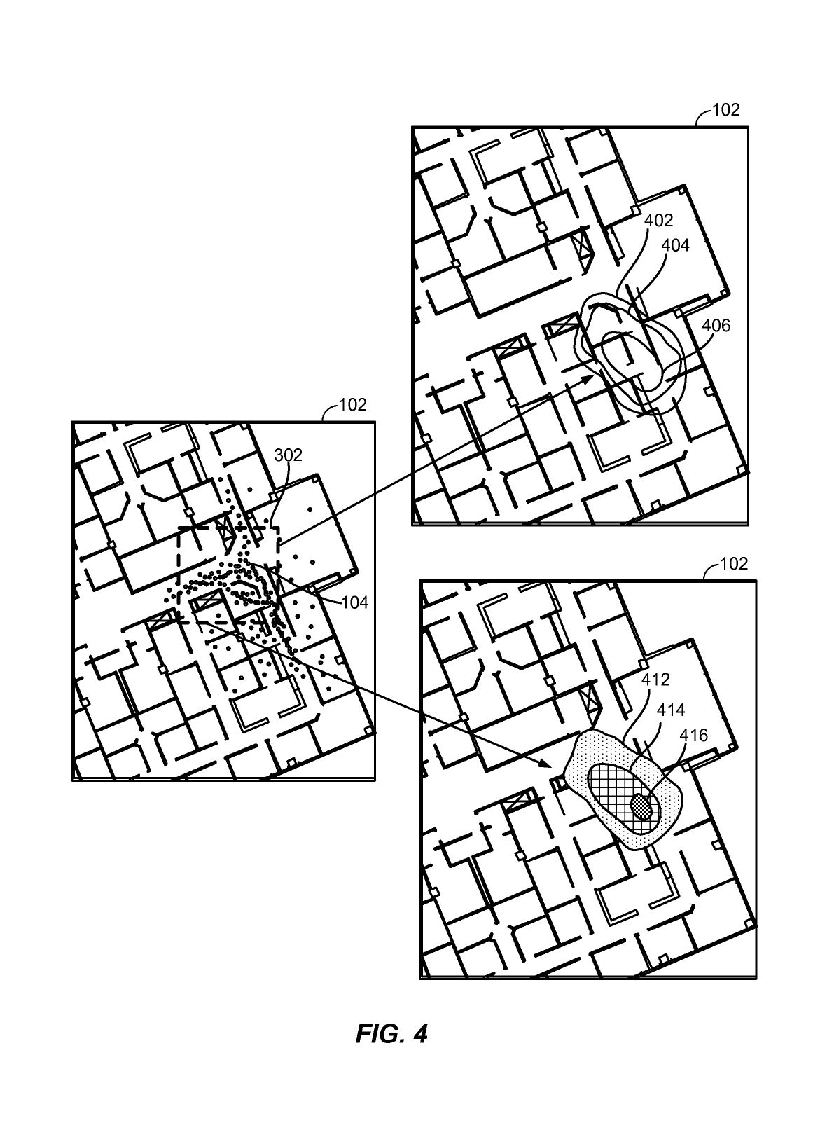

FIG. 4 illustrates methods of displaying statistical distribution of user locations as a contour map and as a heat map according to some aspects of the present disclosure. In this example, descriptions of the exemplary indoor environment 102, the statistical distribution of user locations 104, the region of interest 302, and the density histogram (not shown) are similar to that of FIG. 3A. In one approach, a contour map is used to show the probability where a user may be. As shown in FIG. 4, contour lines 402, 404, and 406 show increasing likelihood of the estimated locations of a user. Compared to displaying a mean location of the user in FIG. 1, this approach is more informative as it provides the user with indications that it is more likely she is in the corridor, but with some probability that she is in the region within the contours.

In another approach, the density histogram of user locations may be represented as a heat map to indicate the likelihood of the location of a user. As the heat map changes from light to dense, for example from region 412 to region 414 and then to region 416, the likelihood where the user may be located increases. Similarly, this approach provides an informative display of the likely position of the user. With these displays, information of statistical distribution of user locations can be effectively communicated to users via location-based services and navigation services. Note that while FIG. 4 is shown in black and white, the actual implementations may use color to display statistical distribution of user locations as a contour map or as a heat map.

According to embodiments of the present disclosure, the mobile device may be configured, at least in part, to provide location-based services. Examples of location-based services may include, but are not limited to, displaying a map, positioning, personal pedestrian navigation, providing static directions, providing real-time turn-by-turn directions, location-based searching (e.g., searching of local points of interest), or any combination thereof, etc. Implementing a location-based service may involve using or providing any one or more of the following: a schematic map, annotation information for a schematic map, POI information, a connectivity graph, a routing graph, turn-by-turn directional instructions, static directional instructions from one location to another location, or any combination thereof, etc. Other examples of location-based services may include, but are not limited to, routing, position filtering, incentives applications (e.g., offers based on location), or any combinations thereof, etc.

For certain example implementations, schematic map may comprise information descriptive of a layout or physical organization of at least one indoor environment. For example, schematic map may indicate locations of walls, rooms, doors, hallways, dividers, railings, or portals between floors, etc. Indoor environment characteristics may further include a graph. For certain example implementations, a graph may comprise multiple nodes that are interconnected by edges. To create a graph, a grid of points may be overlaid on a schematic map of an indoor environment and lines interconnecting the points may be drawn, by way of example only. A connectivity graph implementation may be created, for example, by limiting interconnecting lines to those lines that are capable of extending from one point to another point without crossing an obstacle, such as an impervious building feature (e.g., a wall). A routing graph implementation may comprise a connectivity graph that includes additional map information corresponding to indoor environment so as to facilitate a determination of a route from one point to another point of indoor environment.

A routing graph may be linked to or otherwise associated with annotation information. A routing graph and annotation information may be included as part of, may be linked to, or may otherwise be associated with a schematic map. Annotation information may comprise POI information, as described herein above, or other information descriptive of attributes of specific locations or aspects of a schematic map or a physical indoor environment to which it corresponds.

A routing graph and annotation information may be used to provide navigation services, such as positioning, providing static directions, providing turn-by-turn directions, or any combination thereof, etc. A navigation service may facilitate travel from a point “A” to a point “B” of e.g. an indoor environment using, for example, a routing graph. A routing graph may be descriptive of feasible areas of a given schematic map and indicate how traversal is possible from one position to another position. For a given indoor environment, a routing graph may comprise a set of nodes and edges that depict feasible areas and traversable paths from one point in an indoor environment to another point. A traversable path may comprise, by way of example but not limitation, a path between any two points that is not blocked by a wall or other obstacle. By way of example but not limitation, annotations may be associated with particular portion(s) of a routing graph. A routing graph may be used to plot a path from one point to another point, including from one annotated area to another annotated area.

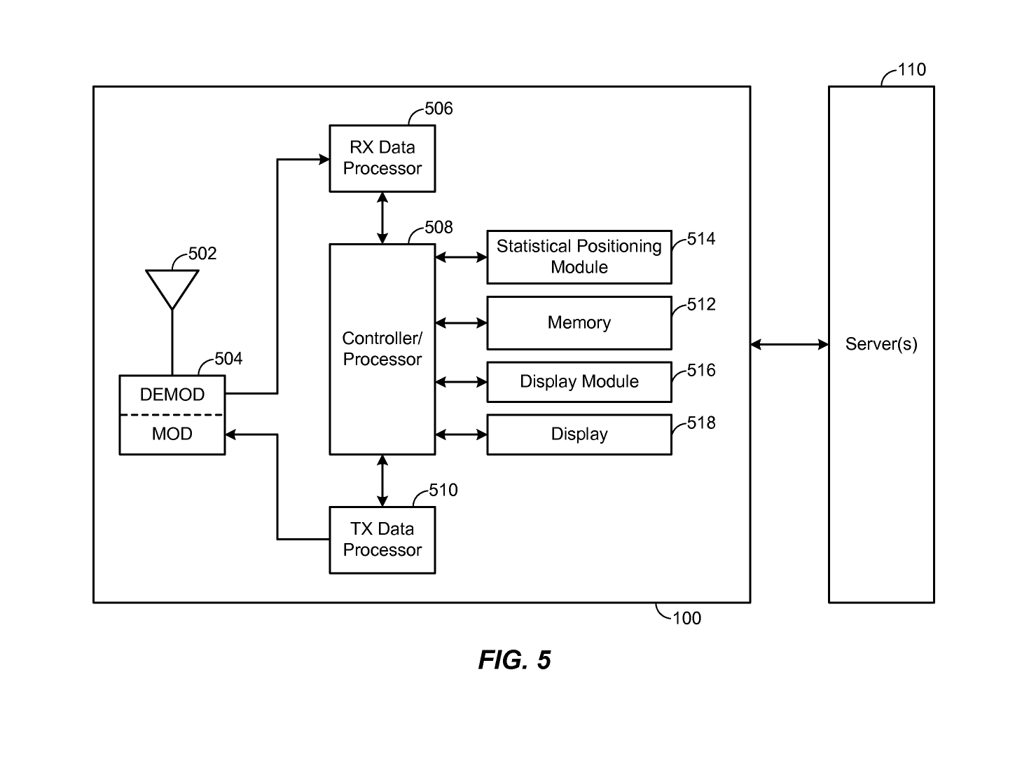

FIG. 5 illustrates a block diagram of an apparatus for providing informative display of statistical positioning information according to some aspects of the present disclosure. As shown in FIG. 5, the apparatus may be a mobile device 100 configured to communicate with one or more servers 110 as described above in association with FIG. 1. Antenna 502 receives modulated signals from a base station and provides the received signals to a demodulator (DEMOD) part of a modem 504. The demodulator processes (e.g., conditions and digitizes) the received signal and obtains input samples. It further performs orthogonal frequency-division multiplexing (OFDM) demodulation on the input samples and provides frequency-domain received symbols for all subcarriers. An RX data processor 506 processes (e.g., symbol de-maps, de-interleaves, and decodes) the frequency-domain received symbols and provides decoded data to a controller/processor 508 of the mobile device 100.

The controller/processor 508 can be configured to control the mobile device 100 to communicate with a server in a wireless network. A TX data processor 510 generates signaling symbols, data symbols, and pilot symbols, which can be processed by modulator (MOD) of modem 504 and transmitted via the antenna 502 to a base station. In addition, the controller/processor 508 directs the operation of various processing units at the mobile device 100. Memory 512 can be configured to store program codes and data for the mobile device. Statistical positioning module 514 can be configured to implement methods described above in association with FIG. 1-4. Display 518 can be configured to display information about statistical distribution of user locations as described above in association with FIG. 1-4. Display module 516 can be configured to control the display 518. Note that in some embodiments, the statistical positioning module 514 may be implemented in server 110, and the results obtained by the statistical positioning module may be communicated from server 110 to mobile device 100.

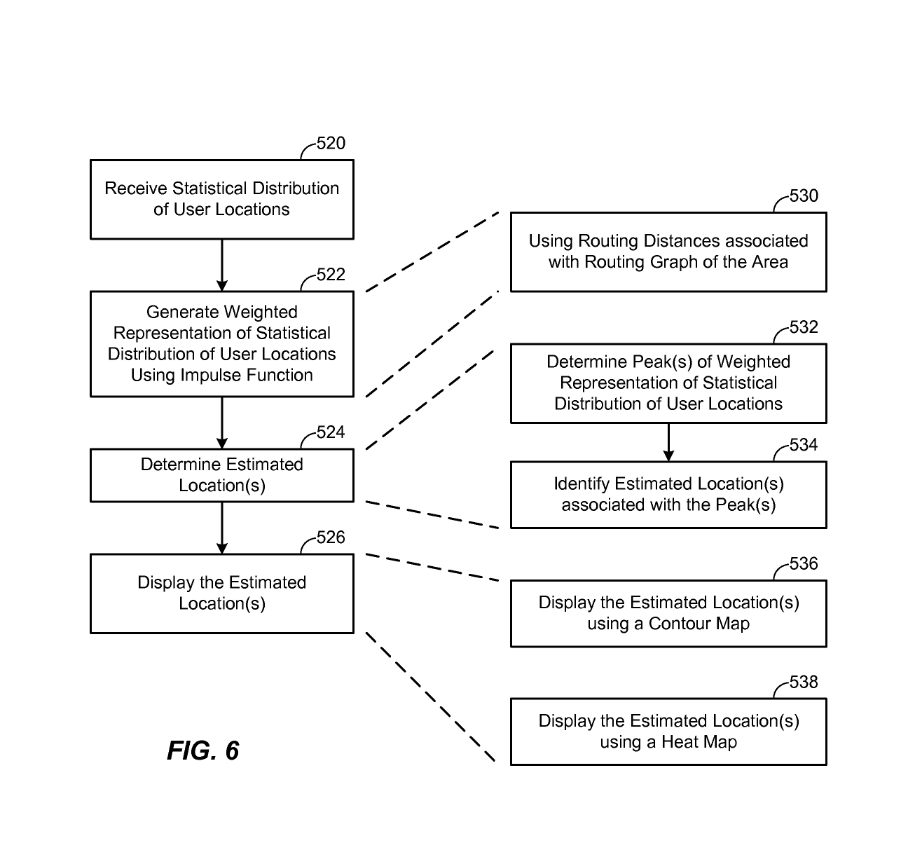

FIG. 6 illustrates an exemplary flow chart implemented by the statistical positioning module of FIG. 5 according to some aspects of the present disclosure. In the exemplary implementation shown in FIG. 6, in block 520, the module receives a statistical distribution of user locations in an area, where the statistical distribution of user locations includes a plurality of points representing likelihood of a user at the corresponding locations. In block 522, the module generates a weighted representation of the statistical distribution of user locations using an inverse distance weighting function. The density histogram is a weighted representation of the statistical distribution of user locations. In block 524, the module generates one or more estimated locations of the user using the density histogram. In block 526, the module displays the one or more estimated locations of the user in a display. For example, the module may display one or more estimated locations using indicia representing density of the one or more estimated locations.

According to embodiments of the present disclosure, block 522 may be implemented at least in part by block 530. In block 530, the module uses routing distances associated with a routing graph of the area to generate the weighted representation of the statistical distribution of user locations. In one approach, the inverse distance weighting function may be inversely proportional to the routing distance from each point of the plurality of points representing likelihood of a user at corresponding locations. Moreover, block 524 may be implemented at least in part by block 532 and block 534. In block 532, the module determines one or more peaks of the density histogram in accordance with a predefined threshold value. In block 534, the module identifies one or more estimated locations associated with the one or more peaks of the density histogram. Furthermore, block 526 may be implemented at least in part by block 536 or block 538. In block 536, the module displays the one or more estimated locations of the user using a contour map, where the contour map represents levels of likelihood the user is in a region. In block 538, the module displays the one or more estimated locations of the user using a heat map, where the heat map represents levels of likelihood the user is in a region.

A server, such as 110 shown in FIG. 1, may store characteristics for multiple indoor environments, e.g., in a database. For example, the server may host one or more schematic maps or other indoor environment characteristics for a venue. Mobile device may therefore acquire indoor schematic maps from server, e.g. after authentication. An interface between mobile devices and server may be specified individually or standardized to enable a schematic map exchange. Server may also provide location(s) of wireless transmitters for a venue. Alternatively, a separate server, such as a server dedicated to providing locations of wireless transmitters at venues, may provide locations of wireless transmitters to mobile devices.

Note that a server may send information to mobile device that enables mobile device to retrieve at least a portion of indoor environment characteristics for an indoor environment of a venue. For example, server may send a location context identifier to mobile device in response to a request. By way of example only, a uniform resource locator (URL), a universal resource indicator (URI), or a combination thereof, etc. that identifies a server or a location on a server (e.g., server, a location on server, or a combination thereof, etc.) having indoor environment characteristics may be sent to mobile device from server. Additionally or alternatively, a local wireless transmitter may broadcast a URL or a URI, or a user of mobile device may search for a URL or a URI via an application or web interface.

According to embodiments of the present disclosure, the disclosed methods may be applied to identify change of status of infeasible areas and map conflicts. For certain example implementations, first incident may involve an area that has been labeled an infeasible area. Mobile device may be located within an area that is identified by annotation information (e.g., POI information) associated with schematic map indicated as an infeasible area. Additionally or alternatively, a mobile device may detect that it is located in area to which a graph does not extend. This may perhaps occur, for instance, when an area that was previously reserved for a food purveyor in a food court of a mall is removed to make room for additional seating space. Mobile device may detect a discrepancy such as an infeasible area label being associated with an area in which they are currently located. A mobile device may detect that it is located within an area that is labeled as an infeasible area by processing annotation information.

For an incident that apparently conflicts with a graph, there may be one or more indications that at least one mobile device is located within an area (i) that is labeled as an infeasible area by annotation information or (ii) to which a graph does not extend. A mobile device may transmit and a server may receive such indications. In response to receiving such indications, server may update a graph corresponding to an indoor environment in which the mobile device(s) are located (i) by labeling the area as a feasible area to produce updated annotation information or (ii) by extending a graph into the area to produce an updated graph. Prior to initiating an updating operation, a server may institute at least one threshold to ensure that a predetermined number of mobile devices are detected as being located within an infeasible area or to ensure that a predetermined period of time over which such conflicting incidents are detected has elapsed, for example.

Note that paragraph [0054]-[0056], FIG. 5, FIG. 6 and their corresponding descriptions provide means for receiving a statistical distribution of user locations in an area, means for generating a weighted representation of the statistical distribution of user locations using an inverse distance weighting function, means for determining one or more estimated locations of the user using the weighted representation of the statistical distribution of user locations. In addition, paragraph [0054]-[0056], FIG. 5, FIG. 6 and their corresponding descriptions provide means for using routing distances associated with a routing graph of the area; means for determining one or more peaks of the weighted representation of the statistical distribution of user locations in accordance with a predefined threshold value; means for identifying a highest peak of the weighted representation of the statistical distribution of user locations as an estimated location of the user; means for identifying one or more peaks of the weighted representation of the statistical distribution of user locations as the one or more estimated locations of the user.

The methodologies and mobile device described herein can be implemented by various means depending upon the application. For example, these methodologies can be implemented in hardware, firmware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. Herein, the term “control logic” encompasses logic implemented by software, hardware, firmware, or a combination.

For a firmware and/or software implementation, the methodologies can be implemented with modules (e.g., procedures, functions, and so on) that perform the functions described herein. Any machine readable medium tangibly embodying instructions can be used in implementing the methodologies described herein. For example, software codes can be stored in a memory and executed by a processing unit. Memory can be implemented within the processing unit or external to the processing unit. As used herein the term “memory” refers to any type of long term, short term, volatile, nonvolatile, or other storage devices and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media may take the form of an article of manufacturer. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above may also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The disclosure may be implemented in conjunction with various wireless communication networks such as a wireless wide area network (WWAN), a wireless local area network (WLAN), a wireless personal area network (WPAN), and so on. The terms “network” and “system” are often used interchangeably. The terms “position” and “location” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network and so on. A CDMA network may implement one or more radio access technologies (RATs) such as cdma2000, Wideband-CDMA (W-CDMA), and so on. Cdma2000 includes IS-95, IS2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A mobile station refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

Designation that something is “optimized,” “required” or other designation does not indicate that the current disclosure applies only to systems that are optimized, or systems in which the “required” elements are present (or other limitation due to other designations). These designations refer only to the particular described implementation. Of course, many implementations are possible. The techniques can be used with protocols other than those discussed herein, including protocols that are in development or to be developed.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations are possible in view of the above teachings. The embodiments were chosen and described to explain the principles of the disclosure and their practical applications, and to enable others skilled in the art to best utilize the disclosure and various embodiments with various modifications as suited to the particular use contemplated.

We claim:

1. A method of providing location information on a mobile device, comprising:
receiving a statistical distribution of user locations in an area, wherein the statistical distribution of user locations includes a plurality of points representing likelihood of a user at corresponding locations;
generating a weighted representation of the statistical distribution of user locations using an inverse distance weighting function;
determining one or more estimated locations of the user using the weighted representation of the statistical distribution of user locations; and
displaying the one or more estimated locations of the user in a display.

2. The method of claim 1, wherein generating a weighted representation of the statistical distribution of user locations comprises:
using routing distance associated with a routing graph of the area, wherein the inverse distance weighting function is inversely proportional to the routing distance in accordance with the routing graph of the area.

3. The method of claim 1, wherein determining one or more estimated locations of the user comprises:
determining one or more peaks of the weighted representation of the statistical distribution of user locations in accordance with a predefined threshold value.

4. The method of claim 3, wherein determining one or more estimated locations of the user further comprises:
identifying a highest peak of the weighted representation of the statistical distribution of user locations as an estimated location of the user.

5. The method of claim 3, wherein determining one or more estimated locations of the user further comprises:
identifying the one or more peaks of the weighted representation of the statistical distribution of user locations as the one or more estimated locations of the user.

6. The method of claim 1 further comprising:
providing navigation to a destination based, at least in part, on the one or more estimated locations of the user and a routing graph of the area; and
providing navigation according to routing distances associated with the routing graph of the area.

7. The method of claim 1 further comprising:
providing information about businesses near the one or more estimated locations of the user; and
providing information about on sale merchandise near the one or more estimated locations of the user.

8. The method of claim 1, further comprising displaying the one or more estimated locations of the user using one or more indicia.

9. The method of claim 8, wherein displaying comprises:
displaying the one or more estimated locations of the user using a contour map, wherein the contour map represents levels of likelihood the user is in a region.

10. The method of claim 8, wherein displaying further comprises:
displaying the one or more estimated locations of the user using a heat map, wherein the heat map represents levels of likelihood the user is in a region.

11. A computer program product for providing location information to a user, comprising a non-transitory medium storing computer programs for execution by one or more computer systems, the computer program product comprising:
code for receiving a statistical distribution of user locations in an area, wherein the statistical distribution of user locations includes a plurality of points representing likelihood of a user at corresponding locations;
code for generating a weighted representation of the statistical distribution of user locations using an inverse distance weighting function;
code for determining one or more estimated locations of the user using the weighted representation of the statistical distribution of user locations; and
code for displaying the one or more estimated locations of the user in a display.

12. The computer program product of claim 11, wherein code for generating a weighted representation of the statistical distribution of user locations comprises:
code for using routing distance associated with a routing graph of the area, wherein the inverse distance weighting function is inversely proportional to the routing distance in accordance with the routing graph of the area.

13. The computer program product of claim 11, wherein code for determining one or more estimated locations of the user comprises:
code for determining one or more peaks of the weighted representation of the statistical distribution of user locations in accordance with a predefined threshold value.

14. The computer program product of claim 13, wherein code for determining one or more estimated locations of the user further comprises:
code for identifying a highest peak of the weighted representation of the statistical distribution of user locations as an estimated location of the user.

15. The computer program product of claim 13, wherein code for determining one or more estimated locations of the user further comprises:
code for identifying the one or more peaks of the weighted representation of the statistical distribution of user locations as the one or more estimated locations of the user.

16. The computer program product of claim 11 further comprising:
code for providing navigation to a destination based, at least in part, on the one or more estimated locations of the user and a routing graph of the area; and
code for providing navigation according to routing distances associated with the routing graph of the area.

17. The computer program product of claim 11 further comprising:
code for providing information about businesses near the one or more estimated locations of the user; and
code for providing information about on sale merchandise near the one or more estimated locations of the user.

18. The computer program product of claim 11, further comprising code for displaying the one or more estimated locations of the user using one or more indicia.

19. The computer program product of claim 18, wherein code for displaying comprises:
code for displaying the one or more estimated locations of the user using a contour map, wherein the contour map represents levels of likelihood the user is in a region.

20. The computer program product of claim 18, wherein code for displaying further comprises:
code for displaying the one or more estimated locations of the user using a heat map, wherein the heat map represents levels of likelihood the user is in a region.

21. A mobile device, comprising:
one or more processors;
a statistical positioning module, configured to work with the one or more processors, wherein the statistical positioning module includes
logic configured to receive a statistical distribution of user locations in an area, wherein the statistical distribution of user locations includes a plurality of points representing likelihood of a user at corresponding locations;
logic configured to generate a weighted representation of the statistical distribution of user locations using an inverse distance weighting function;
logic configured to determine one or more estimated locations of the user using the weighted representation of the statistical distribution of user locations; and
a display module configured to cause a display to show the one or more estimated locations of the user.

22. The mobile device of claim 21, wherein logic configured to generate a weighted representation of the statistical distribution of user locations comprises:
logic configured to use routing distance associated with a routing graph of the area, wherein the inverse distance weighting function is inversely proportional to the routing distance in accordance with the routing graph of the area.

23. The mobile device of claim 21, wherein logic configured to determine one or more estimated locations of the user comprises:
logic configured to determine one or more peaks of the weighted representation of the statistical distribution of user locations in accordance with a predefined threshold value.

24. The mobile device of claim 23, wherein logic configured to determine one or more estimated locations of the user further comprises:
logic configured to identify a highest peak of the weighted representation of the statistical distribution of user locations as an estimated location of the user.

25. The mobile device of claim 23, wherein logic configured to determine one or more estimated locations of the user further comprises:
logic configured to identify the one or more peaks of the weighted representation of the statistical distribution of user locations as the one or more estimated locations of the user.

26. The mobile device of claim 21, further comprising logic configured to display the one or more estimated locations of the user using one or more indicia.

27. The mobile device of claim 26, wherein logic configured to display comprises:
logic configured to display the one or more estimated locations of the user using a contour map, wherein the contour map represents levels of likelihood the user is in a region.

28. The mobile device of claim 26, wherein logic configured to display further comprises:
logic configured to display the one or more estimated locations of the user using a heat map, wherein the heat map represents levels of likelihood the user is in a region.

29. A system for providing location information on a mobile device, comprising:
one or more processors;
a statistical positioning module, configured to work with the one or more processors, wherein the statistical positioning module includes
means for receiving a statistical distribution of user locations in an area, wherein the statistical distribution of user locations includes a plurality of points representing likelihood of a user at corresponding locations;
means for generating a weighted representation of the statistical distribution of user locations using an inverse distance weighting function;
means for determining one or more estimated locations of the user using the weighted representation of the statistical distribution of user locations; and
a display module configured to cause a display to show the one or more estimated locations of the user.

30. The system of claim 29, wherein means for generating a weighted representation of the statistical distribution of user locations comprises:
means for using routing distance associated with a routing graph of the area, wherein the inverse distance weighting function is inversely proportional to the routing distance in accordance with the routing graph of the area.

31. The system of claim 29, wherein means for determining one or more estimated locations of the user comprises:
means for determining one or more peaks of the weighted representation of the statistical distribution of user locations in accordance with a predefined threshold value.

32. The system of claim 31, wherein means for determining one or more estimated locations of the user further comprises:
means for identifying a highest peak of the weighted representation of the statistical distribution of user locations as an estimated location of the user.

33. The system of claim 31, wherein means for determining one or more estimated locations of the user further comprises:
means for identifying the one or more peaks of the weighted representation of the statistical distribution of user locations as the one or more estimated locations of the user.
